(19) United States
(12) Patent Application Publication
(10) Pub. No.: US 2007/0148516 A1
(43) Pub. Date: Jun. 28, 2007

(54) Solid oxide fuel cell stack

(75) Inventor: Bernd Kuhn, Alsdorf (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Munchen (DE)

(21) Appl. No.: 11/640,996

(22) Filed: Dec. 19, 2006

(30) Foreign Application Priority Data
Dec. 22, 2005 (DE) 10 2005 061 585.6

(51) Int. Cl. H01M 8/12; H01M 8/24

(52) U.S. Cl. 429/32; 429/38

(57) ABSTRACT

The invention relates to a solid oxide fuel cell stack having individual cells arranged above one another, which are each arranged, if required, with contact layers between a top shell and a bottom shell gas-tightly connected with the top shell in the edge region, as well as having gas distributor structures in each case between the top shell of a first individual cell and of the bottom shell of the adjacent individual cell, so that, by way of these gas distributor structures and openings provided in the top shell as well as the bottom shell in the region within the edges, one gas transfer respectively can take place to the facing side of the individual cell. Each individual cell consisting of a substrate with an anode layer, a solid electrolyte layer and a cathode layer applied thereto, and a stress equalizing layer provided with openings and having a thermal expansion behavior essentially identical in the operating temperature range of the fuel cell to that of the solid electrolyte layer being applied to the side of the substrate situated opposite the electrode layers and the electrolyte layer. Preferably, the top shell and the bottom shell and/or the gas distributor structures applied to them in each case are identical parts which are built into the stack while being mutually rotated by 180°.

### BACKGROUND AND SUMMARY OF THE INVENTION

This application claims priority to German Application No. 10 2005 061 585.6, filed Dec. 22, 2005, the entire disclosure of which is hereby incorporated in its entirety.

The invention relates to a solid oxide fuel cell stack having individual cells arranged above one another, which are each arranged, if required, with contact layers between a top shell and a bottom shell gas-tightly connected with the top shell in the edge region, as well as having a gas distributor structure in each case between the top shell of a first individual cell and of the bottom shell of the adjacent individual cell. Concerning the known state of the art, reference is made, in addition to German Patent Document DE 102 38 859 A1, particularly to International Patent Document WO 01/45186 A2.

Solid oxide fuel cells or so-called stacks of individual solid oxide fuel cells (“individual cells”) are to be economically and reliably producible in large-scale production in the near future and, particularly, should also operate reliably without the occurrence of the slightest leakiness or the like in the stack during the operation. The latter problems are often caused by different thermal coefficients of expansion of the individual elements or components of the fuel cell stack. A considerable improvement of these problems can be achieved by means of the last-mentioned known state of the art, specifically in that a voltage-equalizing layer provided with openings (specifically for a gas supply to the anode layer through the gas-permeable substrate) is applied quasi to the underside of a substrate which, on its top side, carries an individual fuel cell in the form of an anode layer, a solid electrolyte layer applied thereto, and a cathode layer applied to the latter, which stress equalizing layer has a thermally caused expansion and shrinkage behavior in the temperature range required for the production and for the operation of the electrode-electrolyte unit, which expansion and shrinkage behavior is essentially identical with that of the solid electrolyte layer.

However, this state of the art known from International Patent Document WO 01/45186 does not meet the first mentioned requirements with respect to an economical and reliable producibilty. Therefore, there remains a need for a solid oxide fuel cell stack that is economically and reliably producible in large-scale production that operates reliably without the occurrence of the slightest leakiness or the like in the stack during the operation.

By means of the characteristics according to the invention, first—as basically known—so-called “symmetrical” individual cells are used (as anode-electrolyte-cathode units), which are optimized such that they have essentially no or, at the most, only a minimal change of curvature in the complete operating temperature range (starting at the ambient temperature and ranging to the continuous operation). As it is known, this is achieved such by a “partially symmetrical” construction with respect to the substrate carrying the anode-electrolyte-cathode layers that a so-called voltage-equalizing layer with a comparable thermal expansion behavior is applied to the underside of the substrate (compare, the above-mentioned International Patent Document WO 01/45186), which may be formed, for example, by the material of the solid electrolyte layer. Each so-called “symmetrical” individual cell is furthermore quasi enclosed between a top shell and a bottom shell, so that a self-sufficient so-called individual cell unit is thereby created. In the edge region, the top shell and the bottom shell are connected with one another in a gas-tight manner, so that that a transfer of process gases to the cathode or to the anode of the individual cell from the outside can only still take place through openings which are provided in the top shell and the bottom shell within the edge region. Each such individual cell unit closed off, with the exception of the openings, can therefore be produced separately and can advantageously also be checked separately with respect to its working capability.

A solid oxide fuel cell stack can then be constructed of several individual-cell units already checked first. In this case, suitable so-called gas distributor structures only still have to be inserted between the individual units, by means of which gas distributor structures, the process gases (for example, hydrogen as the fuel gas for the anode and ambient air with oxygen as the oxidant for the cathode) are guided separately from one another to the respective electrode layers or to the openings in the respective plate (top shell or bottom shell) from the lateral direction, and the reaction products are also discharged again. For this purpose, these gas distributor structures may be constructed, for example, in the fashion of a corrugated sheet. With respect to a use of identical parts, it is particularly advantageous for not only the gas distributor structures but also the top shell and the bottom shell to be constructed such that all gas distributor structures and all plates respectively are identical parts. The top shell and the bottom shell are disposed in a manner rotated by 180° with respect to one another in an individual-cell unit; and also mutually adjacent gas distributor structures constructed, for example, in the form of corrugated sheets, may be arranged in the fuel cell stack in a manner rotated by 180° with respect to one another and are therefore not congruent, in order to obtain a sufficiently stiff structure because then, relative to an individual cell, one wave crest and one wave trough respectively are situated opposite one another and thereby quasi clamp this individual cell between one another.

Other objects, advantages and novel features of the present invention will become apparent from the following detailed description of the invention when considered in conjunction with the accompanying drawings for example.

### BRIEF DESCRIPTION OF THE DRAWINGS

FIG. 1a shows a first step for forming a fuel cell stack of one embodiment of the present invention wherein a substrate is provided having a fuel cell formed thereon.

FIG. 1b shows another step for forming a fuel cell stack of one embodiment of the present invention wherein a stress equalizing layer is formed on the underside of the substrate.

FIG. 2 shows another step for forming a fuel cell stack of one embodiment of the present invention wherein a solder connection is formed on the stress equalizing layer.

FIG. 3 shows another step for forming a fuel cell stack of one embodiment of the present invention wherein a bottom shell is provided.

FIG. 4 shows another step for forming a fuel cell stack of one embodiment of the present invention wherein a fuel cell is inserted into the bottom shell.

FIG. 5 shows another step for forming a fuel cell stack of one embodiment of the present invention wherein a solder connection is formed on the bottom shell.

FIG. 6 shows another step for forming a fuel cell stack of one embodiment of the present invention wherein an insulation element is provided over the bottom shell.

FIG. 7 shows another step for forming a fuel cell stack of one embodiment of the present invention wherein a top shell is provided.

FIG. 8 shows another step for forming a fuel cell stack of one embodiment of the present invention wherein a cathode contact element is provided to the top shell.

FIG. 9 a cross-sectional view of a completed fuel cell stack of one embodiment of the present invention.

FIG. 10 shows a three-dimensional view of a portion of fuel cell stack of one embodiment of the present invention.

### DETAILED DESCRIPTION OF THE DRAWINGS

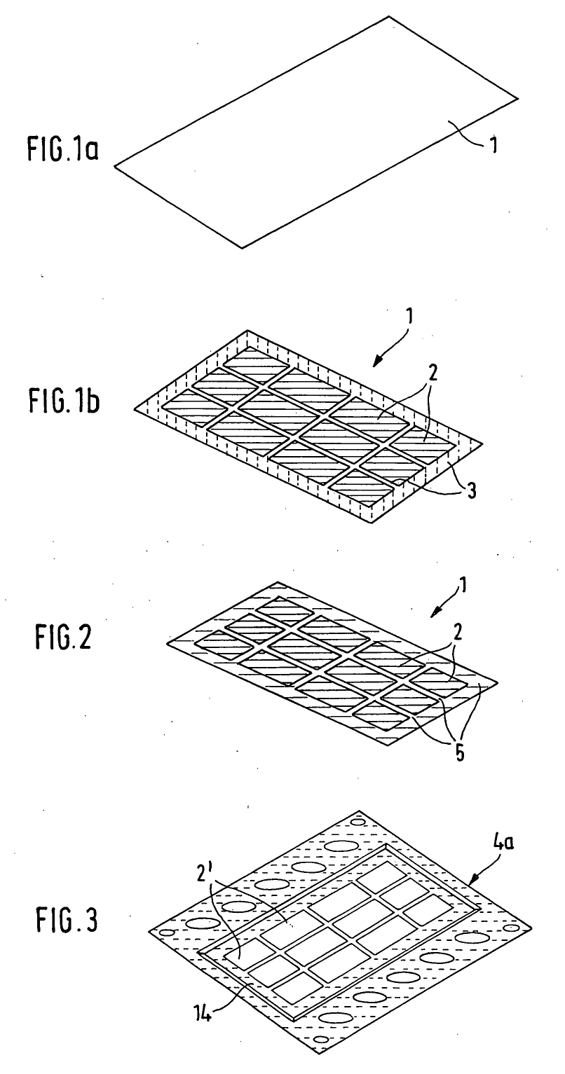

Based on FIG. 1a, this is a physical view of an individual fuel cell (or its top side) characterized below by reference number 1 in the form of a cathode-electrolyte-anode unit or also a so-called electrode-electrolyte unit situated on a substrate. This is essentially a plate-shaped structure with layers situated above-one one another, consisting of a substrate of a thickness of up to 1 mm, to which extremely thin active layers situated above one another in the form of an anode layer, an electrolyte layer disposed thereon and a cathode layer disposed on the latter are applied, as basically known to a person skilled in the art. In this case, the substrate is gas permeable in order to permit the admission of reaction gas to the anode layer.

FIG. 1b shows the underside of an individual fuel cell 1 according to the invention, to which or to whose substrate a so-called stress equalizing layer 3 provided with openings 2 is applied to the side facing away from the anode layer. This stress equalizing layer 3 is formed of a material which, in the possible operating temperature range of the fuel cell (preferably starting in the range of the minimal cold-start temperature and ranging to the maximal operating temperature), has a thermal expansion behavior which is essentially equal to that of the electrolyte layer of the individual cell. Thereby, as a result of corresponding shaping of the here grid-shaped stress equalizing layer 3, that is, as a result of the shape, size and position of the openings 2 as well as the layer thickness, it can be ensured that the individual cell 1 (with the stress equalizing layer 3) experiences no significant curving at temperature changes; that is, the so-called thermo-bimetal effect does not occur. The material of the stress equalizing layer 3 may, for example, be the solid electrolyte material. In addition, the openings 2 in the stress equalizing layer 3 are required in order to permit—in FIG. 1b from above and in FIG. 1a from below—an admission of process gas to the anode layer as well as a discharge of process gas from the latter (in each case, through the substrate).

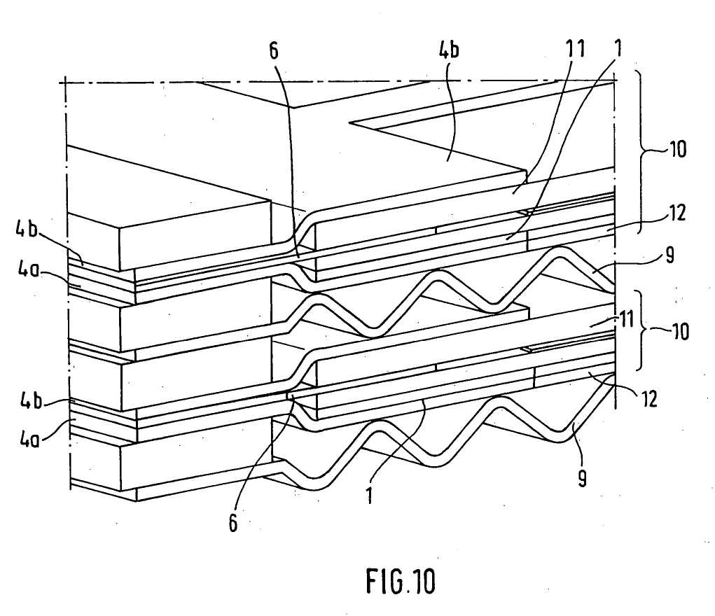

Since the stress equalizing layer 3 has a layer structure which is dense in itself, it is advantageously suitable for a mechanical or material-locking connection with a shell 4 enveloping the individual cell 1, which shell 4 is essentially composed of two half-shells, specifically a so-called bottom shell 4a and a so-called top shell 4b, with respect to which reference is made to FIG. 10. Accordingly, each individual cell 1 is integrated within an enveloping shell 4 and, together with it as well as together with additional elements contained therein, forms a co-called individual-cell unit 10. This will be discussed in greater detail in the following.

First, the individual cell 1 is now prepared for a soldering by way of its stress equalizing layer 3, which preferably operates additionally as a connection layer for fixing the individual cell 1 in a or the above-mentioned enveloping shell 4. For this purpose, a metal solder 5 is applied to the stress equalizing layer 3—starting from the condition according to FIG. 1b—precisely to the grid structure of the stress equalizing layer 3, so that an individual cell 1 is obtained, as illustrated in FIG. 2.

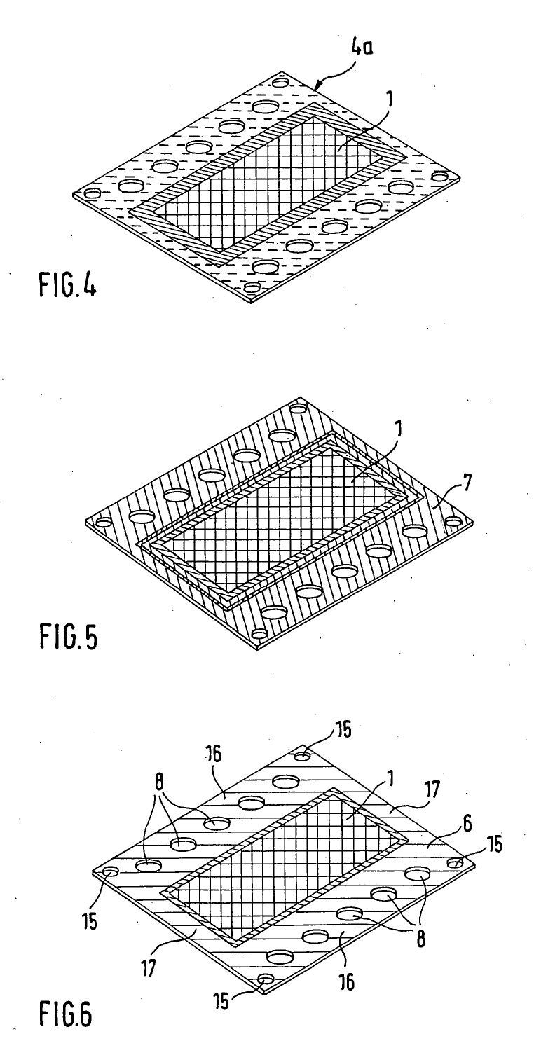

A so-called bottom shell 4a of the enveloping shell 4, which is formed by this bottom shell 4a as well as a so-called top shell 4b corresponding therewith, is illustrated separately in FIG. 3 in a three-dimensional top view. As shown, preferably an appropriately shaped flat concavity 14 for receiving the individual cell 1 is provided in the bottom shell 4a. Furthermore, openings 2′ are also provided in the bottom shell 4a in this concavity 14, which openings 2′ are congruent with the openings 2 in the stress equalizing layer 3, so that, when the individual cell 1 (compare FIG. 4) is inserted into the bottom shell 4a, a process gas exchange becomes possible with the anode layer of the individual cell 1 from below through the openings 2′ and 2 as well as through the substrate of the individual cell 1. A gas-tight bond is hereby created toward the top side of this composite of the individual cell 1 and the bottom shell 4a according to FIG. 4 at least if the edge of the individual cell 1 has a gas-tight construction (as, for example, in the case of the so-called MICs=manifold-integrated cells). If, in contrast, the individual cell 1 itself has no gas-tight edge, it is required to provide a suitable gas-tight sealing measure. For this purpose, preferably an electrically insulating, so-called insulation element 6, which is visible in FIG. 6, will be discussed in detail below and is provided in the edge region between the bottom shell 4a and the top shell 4b, can be gas-tightly connected additionally with the top side of the electrolyte layer of the individual cell 1, in order to create a gas-tight separation of the two-so-called electrode spaces of the individual cell 1 from one another. In this case, the so-called electrode spaces are situated within the individual cell unit 10, and are specifically separated from one another by the solid electrolyte layer of the individual cell 1, on its anode side or on its cathode side.

Returning to the above-mentioned gas-tight sealing by means of the insulation element 6, this can again take place by means of a metal solder, as illustrated in FIG. 5, according to which, a metal solder 7 is applied in the interior edge region of the centrally recessed insulation element 6 then placed according to FIG. 6 to the electrolyte layer of the individual cell 1 laterally projecting beyond the cathode layer of the individual cell 1. In the next step, as mentioned above, insulation element 6 is then placed on the bottom shell 4a with the applied metal solder 7, after which the structure illustrated in FIG. 6 is achieved. In this context, reference is made to several, here circular openings 8 which are provided in two mutually opposite edge strips 16 of the bottom shell 4a as well as of the insulation element 6, by way of which openings 8, the processes gases can be supplied through the completed fuel cell stack into the spaces between mutually adjacent individual-cell units or their top shells and bottom shells. Struts can be fitted through four additional openings 15 provided in the corners, which means of which struts the fuel cell stack is then held together.

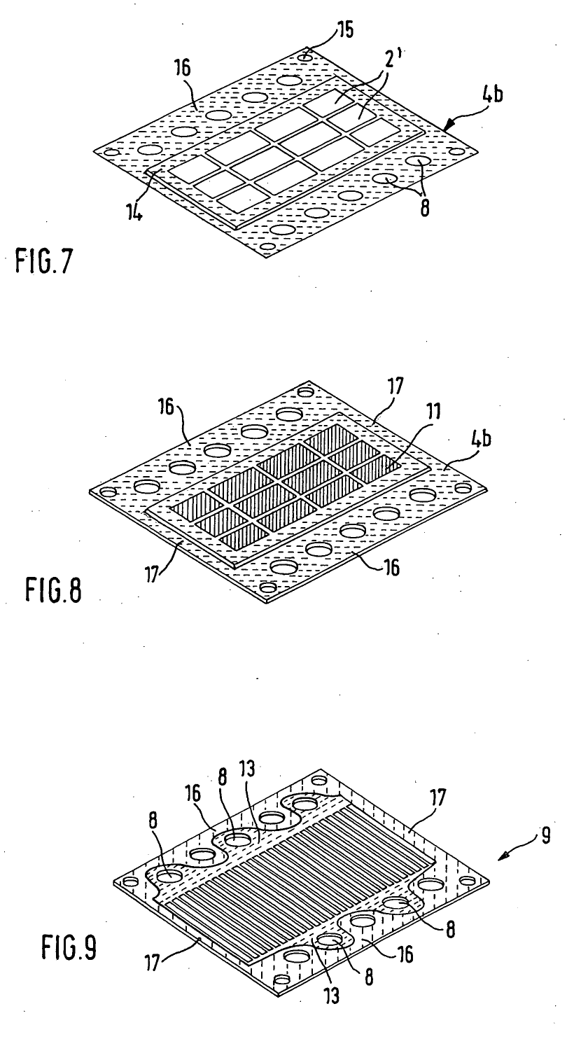

FIG. 7 shows a so-called top shell 4b which is placed on the bottom shell 4a with an integrated individual cell 1 and an insulation element 6 disposed in-between, so that a shell 4 is thereby formed which envelopes the individual cell 1 and thereby completes the so-called individual-cell unit 10. Two individual-cell units 10 of this type are illustrated in FIG. 10 stacked above one another with an intermediate layer of a gas distributor structure 9 which will be explained in the following. Like the bottom shell 4a, the top shell 4b of such an individual-cell unit 10 has openings 2′ for the supply and removal of process gas. According to a preferred embodiment, the top shell 4b and the bottom shell 4a are identical parts which are installed while being rotated 180° with respect to one another, so that the top shell 4b therefore also has a central concavity 14.

Before the top shell 4b and the bottom shell 4a are combined to form the “enveloping” shell, a metallic, electrically conductive, so-called cathode contact element 11 is applied, for example, by means of capacitor discharge welding to the interior side of the top shell 4 facing the individual cell 1, which cathode contact element 11 is or will be provided with a chrome blocking contact layer in the direction of the top side (FIG. 8). This cathode contact element has to be gas permeable at least in the area of the openings 2′

For a gas-tight joining operation of the bottom shell 4a and the top shell 4b in the surrounding edge region (edge strips 16 and transverse strips 17 connecting the latter), suitable metallic solders can be used. Since, however, the top shell 4b and the bottom shell 4a have to be electrically insulated with respect to one another, either the mutually facing surfaces in the edge region (edge strips 16 and transverse strips 17) of the preferably metallic top shell 4b and bottom shell 4a may the ceramized in an electrically non-conductive manner, or a ceramic foil or an electrically non-conductively coated metal element can be placed in-between as an above-mentioned electrical insulation element 6. During the soldering-together of the top shell 4b and the bottom shell 4a, the individual cell 1 is simultaneously connected with the bottom shell 4a by way of the above-mentioned metal solder 5, and the insulation element 6 is connected by way of the above-mentioned metal solder 7 also with the bottom shell 4a and the top shell 4b. By way of the mentioned cathode contact element 11 and the chrome blocking contact layer situated thereon, the individual cell 1 is electrically contacted with the top shell 4a. To this extent, an individual-cell unit 10 is therefore created by means of the individual cell 1 enveloped in this manner, in which individual-cell unit 10,—if the top shell 4b and the bottom shell 4a had no openings 2′—the individual cell 1 would be hermetically enclosed, in which case the so-called anode space—where the anode of the individual cell 1 is situated—within this composite, cannot interact with the so-called cathode space of this composite.

Several such individual-cell units 10 are then combined to form a fuel cell stack while being stacked upon one another. However, it is required in this case that the above-mentioned so-called gas distributor structure 9 be provided between the top shell 4b of a “lower” individual cell unit 10 and the bottom shell 4a of the individual cell unit 10 situated over it, which gas distributor structure 9 permits the required process gas supply and removal. Such a gas distributor structure 9 can optionally still before the soldering-together of the top shell 4b and the bottom shell 4a, be welded, for example, by means of cathode discharge welding, upon the exterior side of the top shell 4b or of the bottom shell 4a. This gas distributor structure 9 is preferably also welded to the shell 4a and 4b respectively (preferably by means of a laser) in the edge regions (edge strips 16 and transverse strips 17), in order to increase the stiffness of the individual-cell unit 10. Preferably, an identical or a comparable material is selected for the shells 4a, 4b as well as for the gas distributor structure 9, so that no thermomechanically caused curvature effects occur during temperature changes.

The suggested laser-welding of the gas distributor structure 9 to the individual-cell unit 10 in its edge region makes a separate joining for the soldering-together of the individual cells 1 by operating the fuel cell stack at a raised temperature superfluous—which had taken place so far and is known to a person skilled in the art, because this joining process takes place together with the suggested laser welding.

As illustrated in FIG. 9 and in FIG. 10, the gas distributor structures 9 in the region within the edge (edge strips 16 and transverse strips 17) may be constructed in the form of a corrugated sheet, having wave crests and wave troughs aligned from one edge strip 16 to the next and extending parallel side-by-side. In order to increase the mechanical stability within the fuel cell stack,—as also illustrated in FIG. 10—two mutually adjacent gas distributor structures 9 as well as a top shell 4b and a bottom shell 4a —are constructed as identical parts and are built into in the fuel cell stack while being mutually rotated by 180°. With respect to an individual-cell unit 10, a so-called wave trough or a so-called wave crest respectively therefore rest against the exterior side of the top shell 4b and of the bottom shell 4a in a mutually directly opposite manner. Process gases are guided in the spaces between the wave crests and the top shell 4a and the bottom shell 4b respectively, specifically introduced on one side (FIG. 10 “front”) and discharged on the opposite side (FIG. 10 “rear”). As illustrated in FIG. 9, so-called gas distributor spaces 13 are in each case, at the end side, assigned to the wave crests, below which the process gases are guided, the respectively assigned openings 8, through which the respective processes gases are supplied on one side and discharged on the other side, leading into the gas distributor spaces 13.

Another, so far not described component inside individual-cell unit 10 is also visible in the fuel cell stack according to FIG. 10, specifically a so-called anode contact element 12 which is provided or operative particularly in the region of the openings 2 in the stress equalizing layer 3 and the openings 2′ of the bottom shell 4a and electrically connects the anode of the individual cell 1 or its substrate with the gas distributor structure 9, which also acts as the so-called bipolar plate in a fuel cell stack known to a person skilled in the art. These gas-permeable anode contact elements may, for example, be nickel grids which, with respect to the length and the width, are adapted to the grid structure in the bottom shell 4a provided here and formed by the openings 2′ and, with respect to the height, are adapted to its thickness. This grids or anode contact elements 12 tap the potential of the anode of the individual cell 1 quasi through the openings 2, 2′ and thus put the latter electrically in contact with the gas distributor structure 9. In this case, these anode contact elements 12 may be material-lockingly connected with the gas distributor structure 9, for example, by means of laser welding or capacitor discharge welding, or may be connected during the construction of the stack, but this as well as a plurality of other details may be designed in a manner deviating from the above explanations without leaving the content of the claims. In particular, so-called global cells, that is, manifold-integrated cells (MICs), can also be used. In this case, congruent “holes” then have to be provided in the entire individual-cell unit 10 together with the openings 2, 2′ and the openings 8 in the top shell 4b and in the bottom shell 4a.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A solid oxide fuel cell stack comprising:
a number n of individual fuel cell units wherein each fuel cell unit comprises a top and bottom; and
a number n+1 of gas distributor structures, wherein a first gas distributor structure is connected to the bottom of a first fuel cell unit, a second gas distributor structure is connected to the top of the first fuel cell unit and the bottom of a second fuel cell unit and each successive fuel cell unit is separated by a successive gas distributor structure and the n+1 gas distributor structure is connected to the top of the nth fuel cell unit,
wherein each individual fuel cell unit comprises:
a bottom shell;
a substrate with a fuel cell comprising an anode layer, a solid electrolyte layer and a cathode layer formed on the top side of the substrate and a stress equalizing layer formed on the underside of the substrate; and
a top shell;
wherein the stress equalizing layer comprises a plurality of windows, wherein the bottom and top shells each comprises a plurality of windows corresponding to the windows in the stress equalizing layer, wherein the bottom and top shells form a gas-tight envelope around the fuel cell such that there is no gas transfer between the fuel cell and the interior of the gas tight envelope, and wherein the stress equalizing layer is characterized by a thermal expansion behavior essentially identical in the operating temperature range of the fuel cell to that of the solid electrolyte layer; and
wherein the gas distributor structures are arranged in relation to the individual fuel cell units such that gas transfer can take place between a given gas distributor structure and the anode layer of the fuel cell of a given fuel cell unit connected to the given gas distributor structure through the plurality of windows in the bottom shell and stress equalizing layer and such that gas transfer can take place between the next successive gas distributor structure and the cathode layer of the fuel cell of the given fuel cell unit through the plurality of windows in the top shell.

2. A solid oxide fuel cell stack according to claim 1,
characterized in that the top shells and the bottom shells are identical parts which are built into the stack while being mutually rotated by 180°.

3. A solid oxide fuel cell stack according to claim 1, characterized in that the gas distributor structures are identical parts which are built into the stack with each successive gas distributor structure being mutually rotated by 180°.

4. A solid oxide fuel cell stack according to claim 1, characterized in that the stress equalizing layer comprises the same material as the solid electrolyte material of the fuel cell.

5. A solid oxide fuel cell stack according to claim 4, characterized in that the bottom shell of each individual fuel cell unit comprises a concavity for receiving the individual fuel cell and wherein the stress equalizing layer is soldered in a gas-tight manner to the bottom shell in the location of the concavity.

6. A solid oxide fuel cell stack according to claim 2, characterized in that the stress equalizing layer comprises the same material as the solid electrolyte material of the fuel cell.

7. A solid oxide fuel cell stack according to claim 6, characterized in that the bottom shell of each individual fuel cell unit comprises a concavity for receiving the individual fuel cell and wherein the stress equalizing layer is soldered in a gas-tight manner to the bottom shell in the location of the concavity.

8. A solid oxide fuel cell stack according to claim 7,
characterized in that the top shell and the bottom shell are identical parts which are built into the stack while being mutually rotated by 180°.

9. A solid oxide fuel cell stack according to claim 8,
characterized in that each fuel cell unit further comprises a cathode contact element in the concavity of the top shell.

10. A solid oxide fuel cell stack according to claim 9,
characterized in that the cathode contact element comprises a chrome blocking layer.

11. A solid oxide fuel cell stack according claim 1,
characterized in that the individual fuel cell is formed without a gas-tight edge and wherein the gas tight envelope is provided by a suitable gas-tight insulation element provided between the solid electrolyte layer of the individual fuel cell and the edge of the bottom shell and the top shell.

12. A solid oxide fuel cell stack according to claim 1,
characterized in that, in each individual fuel cell unit the individual fuel cell is mechanically or material-lockingly connected by way of the stress equalizing layer to the bottom shell.

13. A solid oxide fuel stack according claim 1,
characterized in that the gas distributor structures are constructed in the form of a corrugated sheet.

14. A solid oxide fuel stack according to claim 1,
characterized in that the bottom and top shells of each fuel cell unit further comprise a plurality of openings in edge portions surrounding the fuel cell.

15. A solid oxide fuel stack according to claim 14,
characterized in that each gas distributor structure comprises a corrugated structure comprising a plurality of alternating crests and troughs and wherein each successive gas distributor structure is arranged opposite the previous gas distributor structure such that each fuel cell unit is contacted by a plurality of crests on the exterior of the bottom shell and a plurality of corresponding troughs on the exterior of the top shell and wherein each space between each successive crest contacting the bottom shell is in line with at least one of the plurality of windows in the stress equalizing layer and in line with at least one of the plurality of openings in the edge portion of the bottom shell and wherein each space between each successive trough contacting the top shell is in line with at least one of the plurality of windows in the top shell and in line with at least one of the plurality of openings in the edge portion of the top shell.

16. A solid oxide fuel cell stack according to claim 1,
characterized in that each fuel cell unit further comprises an anode contact element in the space between the plurality of windows in the stress equalizing layer.

17. A solid oxide fuel cell stack according claim 1,
characterized in that the individual fuel cell of each fuel cell unit comprises a gas-tight edge.

18. A solid oxide fuel cell stack according claim 17,
characterized in that the individual fuel cells comprise manifold-integrated cells.

19. A method for forming a solid oxide fuel cell stack, the method comprising:
a. providing a gas permeable substrate having a topside and an underside in the shape of an individual fuel cell;
b. forming an anode layer over the topside of the substrate;
c. forming an electrolyte layer over the anode layer;
d. forming a cathode layer over the electrolyte layer;
e. providing a stress equalizing layer on the underside of the substrate, wherein the stress equalizing layer comprises a material having a thermal expansion coefficient in the operating temperature range of the fuel cell substantially equal to that of the electrolyte layer and wherein the stress equalizing layer comprises a plurality of windows such that process gasses can pass to and from the anode layer by passing through the stress equalizing layer and the substrate;
f. providing a bottom shell wherein the bottom shell comprises:
i. a central cavity similar in size and shape to the individual fuel cell wherein the central cavity comprises a plurality of windows corresponding to the windows in the stress equalizing layer;
ii. mutually opposite side edge portions wherein each side edge portion comprises a plurality of gas channel openings such that process gasses can flow through the bottom shell to the individual fuel cell; and
iii. mutually opposite transverse edge portions;
g. providing the individual fuel cell with the stress equalizing layer facing down into the bottom shell cavity;
h. providing insulation means to the bottom shell side edge portions and transverse edge portions wherein the insulation means comprises openings corresponding to each process opening in the bottom shell, such that the insulation means together with the electrolyte layer forms a gas-tight separation of the cathode and anode;
i. providing a top shell identical to the bottom shell;
j. forming a cathode contact element over the central cavity of the top shell wherein the cathode contact element comprises a chrome blocking layer;
k. providing the top shell with the cathode contact element facing down over insulation means;
l. connecting the top shell to the insulation means such that the bottom and top shells form a gas-tight envelope around the individual fuel cell;
m. providing an anode contact element to the underside of the substrate in the space provided by the windows in the stress equalizing layer and the bottom shell thereby forming an individual fuel cell unit;
n. repeating the above steps a. through m. to form a plurality of individual fuel cell units;
o. providing a gas distributor structure to the exterior of the bottom shell of a selected one of the individual fuel cell units such that the gas distributor structure forms an electrical connection to the substrate of the fuel cell unit via the anode contact element;
p. providing an identical gas distributor structure rotated 180° to the exterior of the top shell of the selected fuel cell unit; and
q. repeating the above steps o. through p. such that a stack of fuel cell units is formed with gas distributor structures between each fuel cell unit and with a gas distributor structure over the top fuel cell unit in the stack wherein each gas distributor structure is connected to the top shell of a lower fuel cell unit and to the bottom shell of a higher fuel cell unit and wherein each gas distributor structure is characterized by a corrugated shape and is connected to the fuel cell units such that process gasses can travel through from the process gas holes in the bottom and top shells through the channels formed by the corrugation and into the anode layer and cathode layer of each fuel cell unit.
